(19) United States
(12) Patent Application Publication
(10) Pub. No.: US 2012/0119913 A1
(43) Pub. Date: May 17, 2012

(54) CONTROL CIRCUIT

(75) Inventors: SONG YU, Shenzhen City (CN); ZUO-LIN HOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/978,596

(22) Filed: Dec. 26, 2010

(30) Foreign Application Priority Data
Nov. 17, 2010 (CN) 201010547789.4

(51) Int. Cl. G08B 17/00

(52) U.S. Cl. 340/584

(57) ABSTRACT

A control circuit includes a temperature detection circuit, a comparison circuit, and an alarm circuit. The temperature detection circuit detects the temperature of a first socket and outputs a first temperature signal correspondingly. The comparison circuit compares the temperature signal with a reference temperature signal corresponding to a reference temperature, and outputs a control signal according to the comparison result. The alarm circuit alerts the users according to the control signal.

### BACKGROUND

1. Technical Field

The present disclosure relates to a control circuit for a socket.

2. Description of Related Art

When a power plug is connected to a socket with a bad contact, the socket may overheat which could cause a safety hazard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a control circuit including a voltage conversion circuit, a temperature detection circuit, a comparison circuit, an alarm circuit, and a delay switching circuit.

FIGS. 2 and 3 are circuit diagrams of the voltage conversion circuit of FIG. 1.

FIG. 4 is a circuit diagram of a first embodiment of the temperature detection circuit and the comparison circuit of FIG. 1.

FIGS. 5 and 6 are circuit diagrams of the alarm circuit of FIG. 1.

FIG. 7 is a circuit diagram of the delay switching circuit of FIG. 1.

FIG. 8 is a circuit diagram of a second embodiment of the temperature detection circuit and the comparison circuit of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

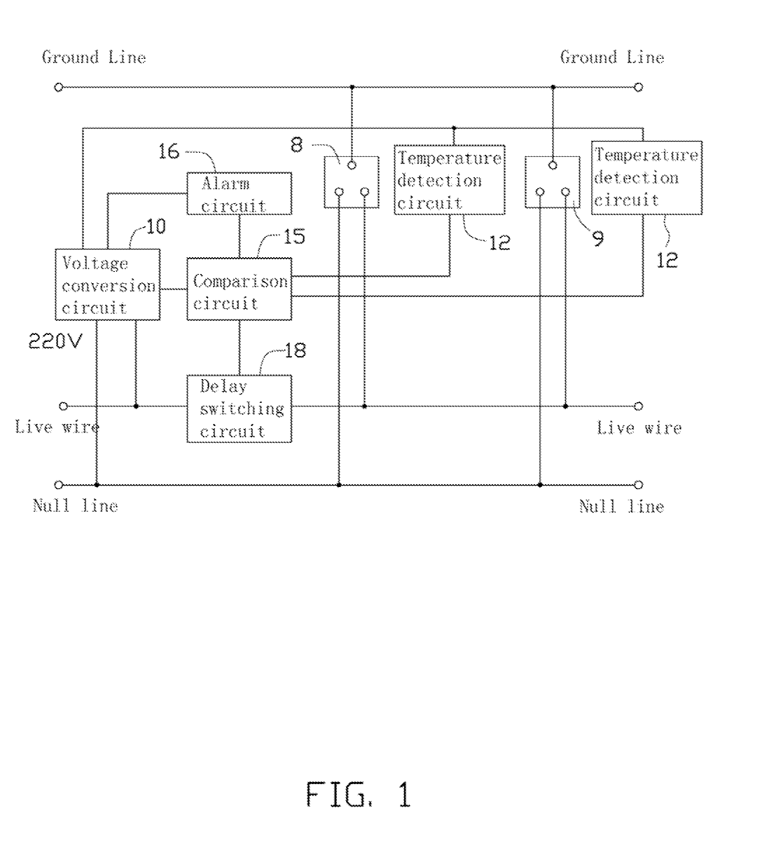

Referring to FIG. 1, an exemplary embodiment of a control circuit includes a voltage conversion circuit 10, two temperature detection circuits 12, a comparison circuit 15, an alarm circuit 16, and a delay switching circuit 18.

The voltage conversion circuit 10 is connected to the temperature detection circuits 12, the comparison circuit 15, the alarm circuit 16, and the delay switching circuit 18, for converting a +220 voltage (V) alternating current (AC) power supply to a +12V direct current (DC) power supply and a +5V DC power supply to supply power.

The temperature detection circuits 12 are set inside a multi way socket. In the embodiment, the multi way socket includes a first socket 8 and a second socket 9. The temperature detection circuits 12 respectively detect the temperature of the first and second sockets 8 and 9, and output corresponding temperature signals to the comparison circuit 15. The comparison circuit 15 compares the temperature signals with a reference temperature signal to determine whether the temperatures at the first socket 8 and the second socket 9 are higher than the reference temperature, and outputs a corresponding control signal according to the comparison result. In other embodiments, the multi way socket may include more than two sockets, and the control circuit may include more than two temperature detection circuits 12.

The alarm circuit 16 alerts users according to the control signal, and the delay switching circuit 18 disconnects the multi way socket from the +220V AC power supply according to the control signal.

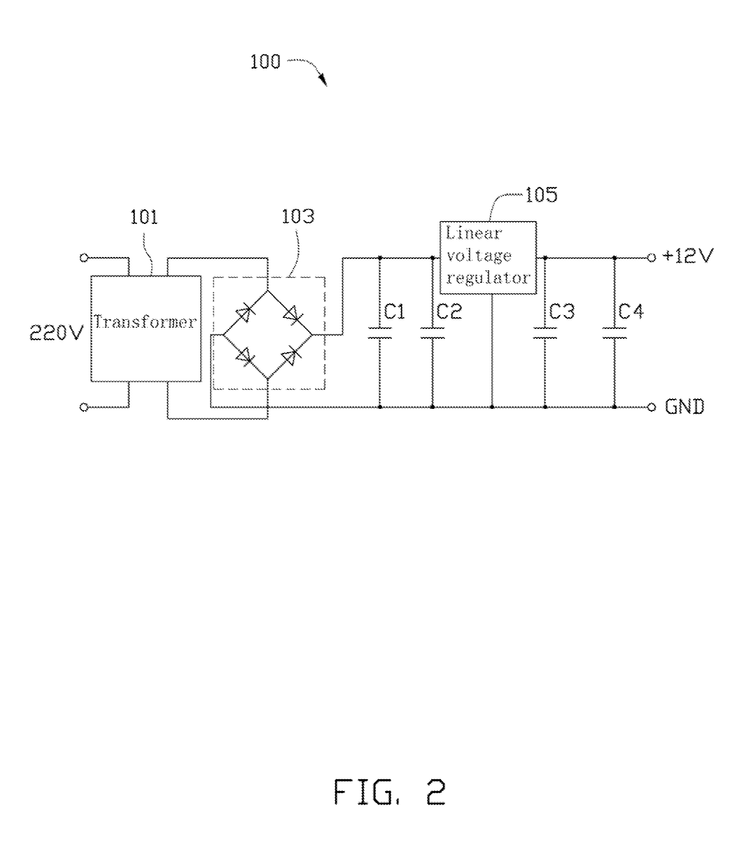

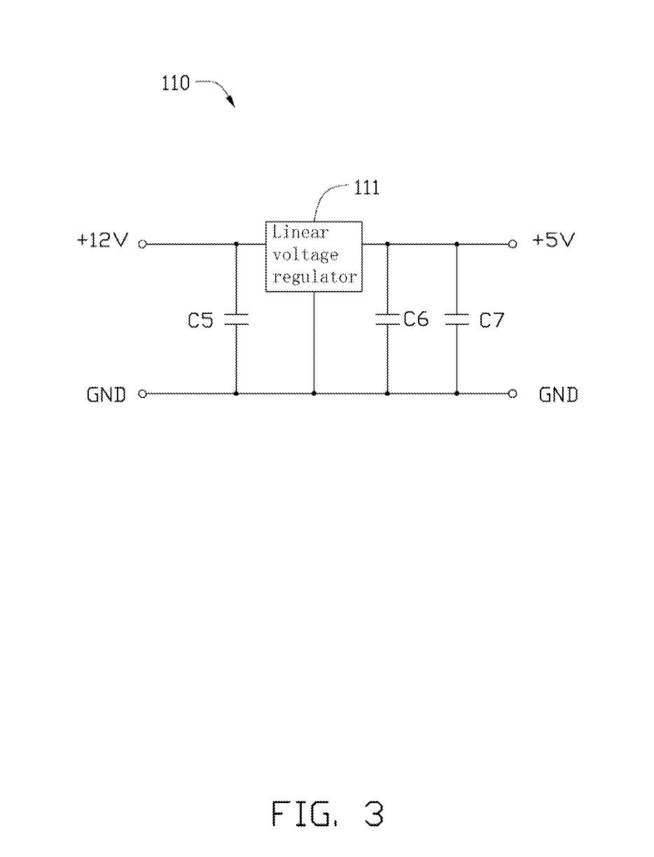

Referring to FIGS. 2 and 3, the voltage conversion circuit 10 includes a first conversion circuit 100 and a second conversion circuit 110. The first conversion circuit 100 converts the +220V AC power supply to the +12V DC power supply. The first conversion circuit 100 includes a transformer 101, a bridge rectifier circuit 103, a linear voltage regulator 105, and four capacitors C1-C4. The second conversion circuit 110 converts the +12V DC power supply to the +5V DC power supply. The second conversion circuit 110 includes a linear voltage regulator 111 and three capacitors C5-C7.

The transformer 101 is connected to the +220V AC power supply, to convert the +220V AC power supply to a +24V AC power supply. Two output terminals of the transformer 101 are connected to two input terminals of the bridge rectifier circuit 103. A first output terminal of the bridge rectifier circuit 103 is connected to an input terminal of the linear voltage regulator 105. A second output terminal of the bridge rectifier circuit 103 is grounded. The capacitor C1 and the capacitor C2 are connected between the first and second output terminals of the bridge rectifier circuit 103 in parallel. A first terminal of the capacitor C3 is connected to an output terminal of the linear voltage regulator 105. A second terminal of the capacitor C3 is grounded. The capacitor C4 is connected to the capacitor C3 in parallel.

An input terminal of the linear voltage regulator 111 is connected to the output terminal of the linear voltage regulator 105, to receive the +12V DC power supply. An output terminal of the linear voltage regulator 111 outputs the +5V DC power supply. A first terminal of the capacitor C5 is connected to the input terminal of the linear voltage regulator 111. A second terminal of the capacitor C5 is grounded. A first terminal of the capacitor C6 is connected to an output terminal of the linear voltage regulator 111. A second terminal of the capacitor C6 is grounded. The capacitor C7 is connected to the capacitor C6 in parallel.

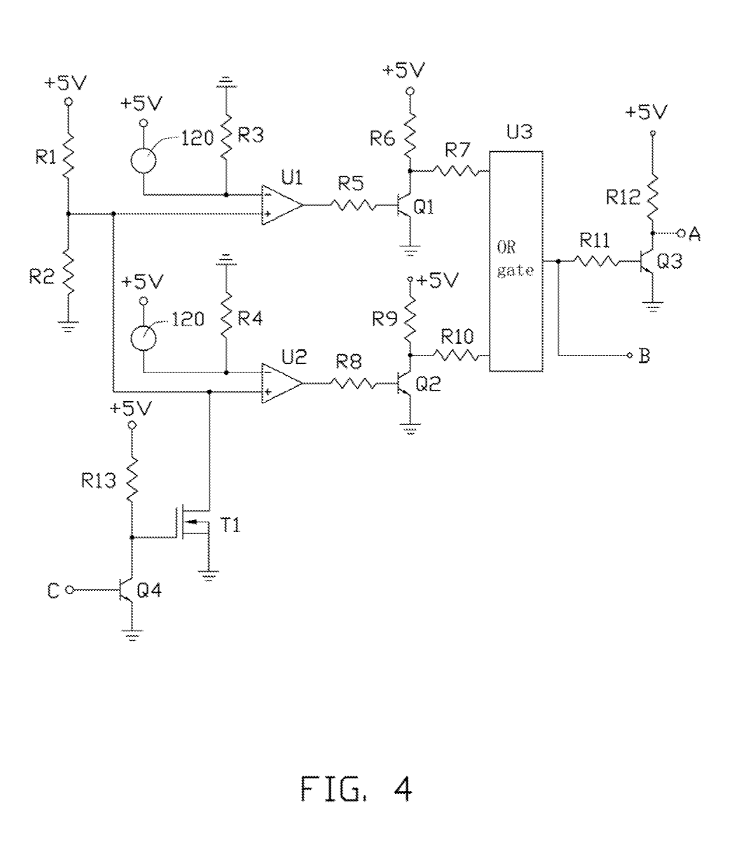

Referring to FIG. 4, each temperature detection circuit 12 includes a temperature sensor 120. A power terminal of each of the temperature sensors 120 is connected to the output terminal of the linear voltage regulator 111, to receive the +5V DC power supply. An output terminal of each of the temperature sensors 120 is connected to the comparison circuit 15. The temperature sensors 120 of the temperature detection circuits 12 respectively sense the temperatures of the first and second sockets 8 and 9.

The comparison circuit 15 includes two resistors R1 and R2, two comparators U1 and U2, four transistors Q1-Q4, an OR gate U3, and a field effect transistor (FET) T1. Inverting terminals of the comparators U1 and U2 are respectively connected to the output terminals of the temperature sensors 120. The inverting terminals of the comparators U1 and U2 are also respectively grounded through resistors R3 and R4. The resistors R1 and R2 are connected in series between the output terminal of the linear voltage regulator 111 and the ground. A node between the resistors R1 and R2 is connected to non-inverting terminals of the comparators U1 and U2. An output terminal of the comparator U1 is connected to a base of the transistor Q1 through a resistor R5. An emitter of the transistor Q1 is grounded. A collector of the transistor Q1 is connected to the output terminal of the linear voltage regulator 111 through a resistor R6. The collector of the transistor Q1 is further connected to a first input terminal of the OR gate U3 through a resistor R7. An output terminal of the comparator U2 is connected to a base of the transistor Q2 through a resistor R8. An emitter of the transistor Q2 is grounded. A collector of the transistor Q2 is connected to the output terminal of the linear voltage regulator 111 through a resistor R9. The collector of the transistor Q2 is further connected to a second input terminal of the OR gate U3 through a resistor R10. An output terminal of the OR gate U3 is connected to the alarm circuit 16. The output terminal of the OR gate U3 is further connected to a base of the transistor Q3 through a resistor R11. An emitter of the transistor Q3 is grounded. A collector of the transistor Q3 is connected to the output terminal of the linear voltage regulator 111 through a resistor R12. The collector of the transistor Q3 is further connected to the alarm circuit 16 and the delay switching circuit 18. The non-inverting terminals of the two comparators U1 and U2 are connected to a drain of the FET T1. A source of the FET T1 is grounded. A gate of the FET T1 is connected to a collector of the transistor Q4. An emitter of the transistor Q4 is grounded. A base of the transistor Q4 is connected to the delay switching circuit 18. The collector of the transistor Q4 is connected to the output terminal of the linear voltage regulator 111 through a resistor R13.

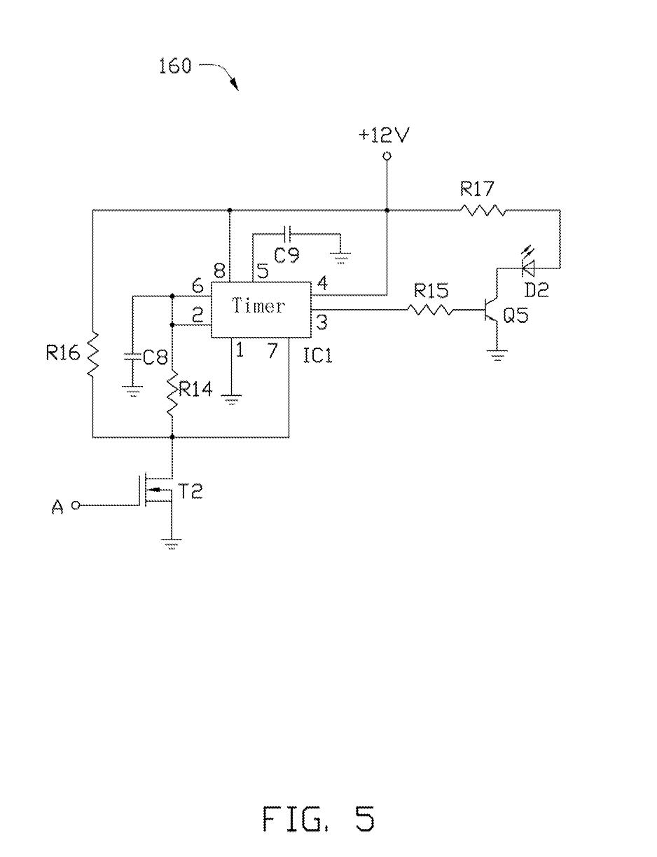

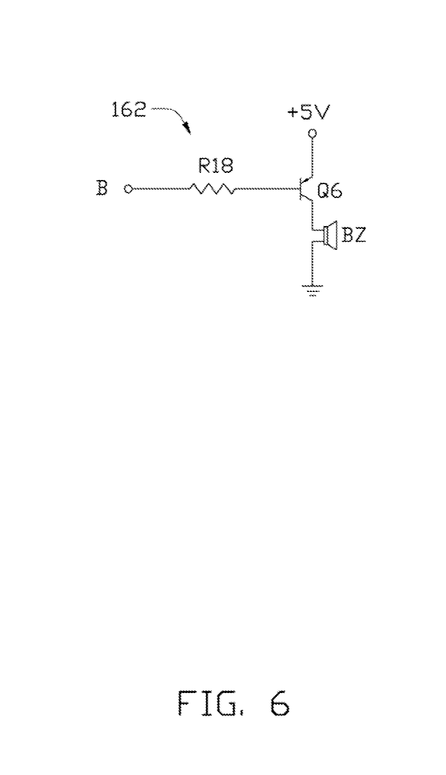

Referring to FIGS. 5 and 6, the alarm circuit 16 includes a luminous alarm circuit 160 and an audible alarm circuit 162. The luminous alarm circuit 160 includes a FET T2, a timer IC1, a transistor Q5, and a light-emitting diode (LED) D2. The audible alarm circuit 162 includes a buzzer BZ and a transistor Q6.

A gate of the FET T2 is connected to the collector of the transistor Q3. A source of the FET T2 is grounded. A drain of the FET T2 is connected to a trigger terminal 2 and a locking terminal 6 of the timer IC1. The locking terminal 6 of the timer IC1 is grounded through a capacitor C8. A ground terminal 1 of the timer IC1 is grounded. An output terminal 3 of the timer IC1 is connected to a base of the transistor Q5 through a resistor R15. A reset terminal 4 of the timer IC1 is connected to the output terminal of the linear voltage regulator 105. A collecting terminal 5 of the timer IC1 is grounded through a capacitor C9. A discharging terminal 7 of the timer IC1 is connected to the output terminal of the linear voltage regulator 105 through a resistor R16. A power terminal 8 is connected to the output terminal of the linear voltage regulator 105. An emitter of the transistor Q5 is grounded. A collector of the transistor Q5 is connected to a cathode of the LED L. An anode of the LED D2 is connected to the output terminal of the linear voltage regulator 105 through a resistor R17.

A first terminal of the buzzer BZ is grounded. A second terminal of the buzzer BZ is connected to a collector of the transistor Q6. An emitter of the transistor Q6 is connected to the output terminal of the linear voltage regulator 111. A base of the transistor Q6 is connected to the output terminal of the OR gate U3.

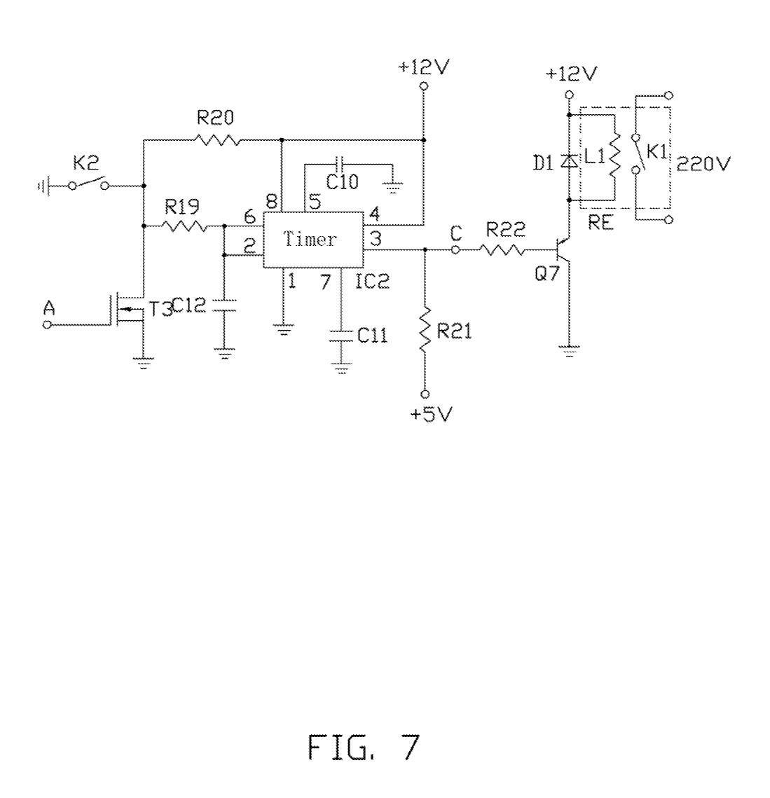

Referring to FIG. 7, the delay switching circuit 18 includes a FET T3, a timer IC2, a transistor Q7, and a delay RE. The delay RE includes a switch K1 and a coil L1.

A gate of the FET T3 is connected to the collector of the transistor Q3. A source of the FET T3 is grounded. A drain of the FET T3 is connected to a trigger terminal 2 and a locking terminal 6 of the timer IC2 through a resistor R19. A ground terminal 1 of the timer IC2 is grounded. An output terminal 3 of the timer IC2 is connected to the base of the transistor Q4. A reset terminal 4 of the timer IC2 is connected to the output terminal of the linear voltage regulator 105. A controlling terminal 5 of the timer IC2 is grounded through a capacitor C10. A discharging terminal 7 of the timer IC2 is grounded through a capacitor C11. A power terminal 8 of the timer IC2 is connected to the output terminal of the linear voltage regulator 105. The trigger terminal 2 is further grounded through a capacitor C12. The output terminal 3 of the timer IC2 is further connected to the output terminal of the linear voltage regulator 111 through a resistor R21. The drain of the FET T3 is connected to the output terminal of the linear voltage regulator 105 through a resistor R20. The drain of the FET T3 is further grounded through a switch K2.

A base of the transistor Q7 is connected to the base of the transistor Q4 through a resistor R22. An emitter of the transistor Q7 is grounded. A collector of the transistor Q7 is connected to an anode of a diode D1. A cathode of the diode D1 is connected to the output terminal of the linear voltage regulator 105. The switch K1 is connected between a live wire of the +220V AC power supply to connect or disconnect the live wire to or from the sockets 8 and 9. The coil L1 is connected to the diode D1 in parallel.

The voltage conversion circuit 10 converts the +220V AC power supply to the +12V DC power supply and the +5V DC power supply.

The temperature sensors 120 respectively sense the temperatures of the first socket 8 and the second socket 9, and respectively output corresponding temperature signals to the comparators U1 and U2. The non-inverting terminals of the comparators U1 and U2 receive the reference temperature signal corresponding to the reference temperature. When the temperature at the first socket 8 or the second socket 9 is higher than the reference temperature, the comparator U1 or U2 outputs a low level signal. The transistor Q1 or Q2 turns off correspondingly. As a result, the first input terminal or the second input terminal of the OR gate U3 receives a high level signal. According to the characteristic of the OR gate, so long as one of the first and second input terminals receives the high level signal, the output terminal of the OR gate U3 outputs a high level signal. Moreover, if the temperatures at the first socket 8 and the second socket 9 are higher than the reference temperature, the comparators U1 and U2 output the low level signals. The transistors Q1 and Q2 turn off. As a result, the first input terminal and the second input terminals of the OR gate U3 receive the high level signals. The OR gate U3 outputs the high level signal.

In the luminous alarm circuit 160, the timer IC1 and the FET T2 compose a multivibrator type oscillator. When the gate of the FET T2 receives a low level signal, the multivibrator type oscillator outputs pulse signals to control the LED D2 to blink. According to detail described above, when the temperature at the first socket 8 or the second socket 9 is higher than the reference temperature, the transistor Q3 turns on. The gate of the FET T2 receives the low level signal. As a result, the multivibrator type oscillator outputs the pulse signals to make the LED D2 blink. Therefore, when the temperature at each of the first socket 8 and the second socket 9 is higher than the reference temperature, the LED D2 blinks to alert users that the multiway socket is in an unsafe state.

In the audible alarm circuit 162, when the OR gate U3 outputs the high level signal, the transistor Q6 turns on. The buzzer BZ is actived to alert users that the multiway socket is in an unsafe state. In other embodiments, the alarm circuit 16 may include only the luminous alarm circuit 160 or the audible alarm circuit 162.

In the delay switching circuit 18, the timer IC2 and the FET T3 compose a delay circuit. When the gate of the FET T3 receives a low level signal, the output terminal 3 of the timer IC2 outputs a low level signal after a period of delay, which is determined by the resistances of the resistors R19 and R20 and the capacitance of the capacitor C12. As a result, the transistor Q7 turns off to make the delay RE turn off. Meanwhile, the transistor Q4 turns off according to the low level signal. The FET T1 turns on to make the non-inverting terminals of the comparators U1 and U2 receive the low signals. In this way if the temperatures at the first socket 8 and the second socket 9 are less than the reference temperature, the comparators U1 and U2 still output the low level signals to avoid the delay RE being turned on.

If the users just want to be alerted when the multiway socket is in the unsafe state, in other words, the multiway socket would not be disconnected when the temperature is higher than the reference temperature, the users can turn on the switch K2. As a result, the trigger terminal 2 of the timer IC2 receives the low level signal. At this condition, the delay RE turns on all the time.

When the temperatures at the first socket 8 and the second socket 9 are less than the reference temperature, the output terminals of the comparators U1 and U2 output the high level signals. The transistors Q1 and Q2 turn on. The first and second input terminals of the OR gate U3 receive the low level signal. As a result, the OR gate U3 outputs the low level signal. At this time, the transistor Q3 turns off to deactive the multivibrator type oscillator. The alarm circuit 16 does not work. Meanwhile, the trigger terminal 2 of the timer IC2 of the delay switching circuit 18 receives the low level signal to make the delay RE be turned on all the time.

According to detail described above, each of the transistors Q1-Q7 and the FETs T1-T3 functions as an electronic switch. In other embodiments, the transistors Q1-Q7 and the FETs T1-T3 can be replaced with other elements, such as different transistors. The electronic switch includes first to third terminals. The base of the transistor Q1 functions as the first terminal of the electronic switch. The collector of the transistor Q1 functions as the second terminal of the electronic switch. The emitter of the transistor Q1 functions as the third terminal of the electronic switch. The second terminal is connected to or is disconnected from the third terminal according to the voltage level of the third terminal of the electronic switch.

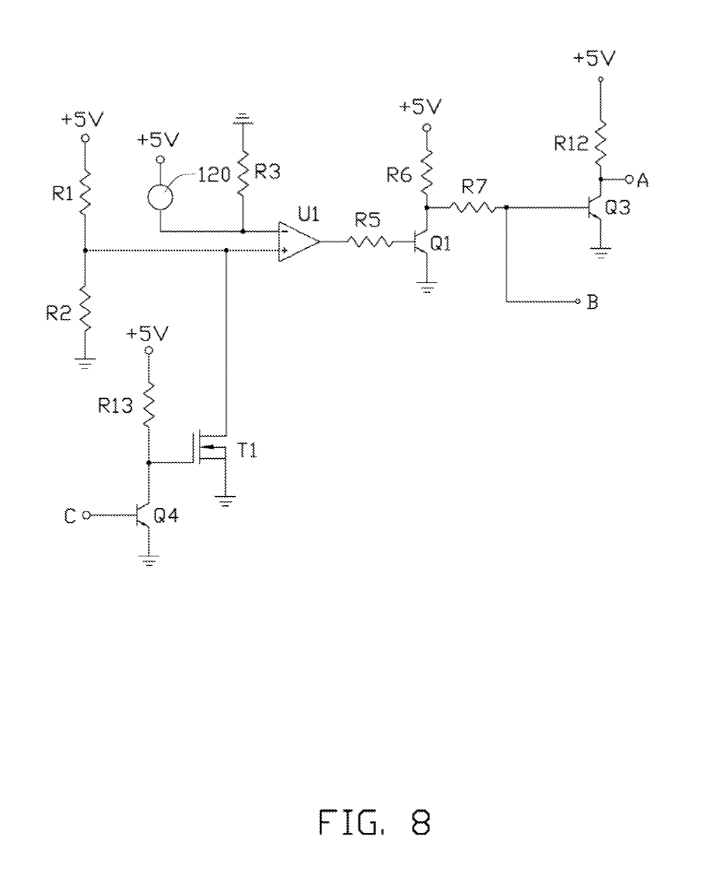

According to detail described above, if the multiway socket just includes only one socket, the control circuit may just include only one temperature detection circuit 12. Referring to FIG. 8, the comparison circuit 16 includes only one comparator U1. The OR gate U3 can be omitted. The collector of the transistor Q1 is connected to the base of the transistor Q3 through the resistor R7.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A control circuit comprising:
a temperature detection circuit to detect the temperature at a first socket and output a first temperature signal correspondingly;
a comparison circuit to compare the temperature signal with a reference temperature signal corresponding to a reference temperature, and output a control signal according to the comparison result; and
an alarm circuit to alert users according to the control signal.

2. The control circuit of claim 1, further comprising a delay switching circuit, wherein the delay switching circuit disconnects the socket from a first power supply according to the control signal.

3. The control circuit of claim 2, wherein the delay switching circuit comprises a delay circuit, a first electronic switch, and a relay, the delay circuit receives the control signal and outputs a delay signal after a period of delay to a first terminal of the first electronic switch to turn off the first electronic switch, a second terminal of the electronic switch is grounded, a third terminal of the electronic switch is connected to an anode of a diode, a cathode of the diode is connected to a second power supply, a coil of the relay is connected to the diode in parallel, a switch of the relay is connected between the socket and the first power supply.

4. The control circuit of claim 3, wherein the delay circuit comprises a second electronic switch and a first timer, a first terminal of the second electronic switch receives the control signal, a second terminal of the second electronic switch is grounded, a third terminal of the second electronic switch is connected to a trigger terminal and a locking terminal of the first timer, the trigger terminal of the first timer is further grounded through a first capacitor, a ground terminal of the first timer is grounded, an output terminal of the first timer outputs the delay signal to the first terminal of the first electronic switch, the output terminal of the first timer is further connected to a third power supply through a second resistor, a reset terminal of the first timer is connected to the second power supply, a control terminal of the first timer is grounded through a second capacitor, a discharge terminal of the first timer is grounded through a third capacitor, a power terminal of the first timer is connected to the second power supply, the third terminal of the second electronic switch is further connected to the second power supply through a third resistor.

5. The control circuit of claim 4, wherein the delay switching circuit further comprises a switch, a first terminal of the switch is grounded, and a second terminal of the switch is connected to the third terminal of the second electronic switch.

6. The control circuit of claim 4, wherein the delay switching circuit further comprises a third electronic switch and a fourth electronic switch, a first terminal of the third electronic switch is connected to the output terminal of the first timer, a second terminal of third electronic switch is grounded, a third terminal of the third electronic switch is connected to the third power supply through a fourth resistor, the third terminal of the third electronic switch is further connected to a first terminal of the fourth electronic switch, a second terminal of the fourth electronic switch is grounded, a third terminal of the fourth electronic is connected to the comparison circuit.

7. The control circuit of claim 1, further comprising a voltage conversion circuit, wherein the voltage conversion circuit converts a first power supply to a second power supply and a third power supply, for supplying power to the temperature detection circuit, the comparison circuit, and the alarm circuit.

8. The control circuit of claim 7, wherein the voltage conversion circuit comprises a first conversion circuit and a second conversion circuit, the first conversion circuit converts the first power supply to the second power supply, the second conversion circuit converts the second power supply to the third power supply.

9. The control circuit of claim 1, wherein the temperature detection circuit comprises a temperature sensor, an output terminal of the temperature sensor is connected to the comparison circuit.

10. The control circuit of claim 1, wherein the comparison circuit comprises a comparator and a fifth electronic switch, a non-inverting terminal of the comparator receives the reference temperature signal, an inverting terminal of the comparator receives the temperature signal, an output terminal of the comparator is connected to a first terminal of the fifth electronic switch, a second terminal of the fifth electronic switch is grounded, a third terminal of the fifth electronic switch is connected to a power supply through a fourth resistor, the third terminal of the fifth electronic switch is further connected to the alarm circuit.

11. The control circuit of claim 1, wherein the temperature detection circuit further detects the temperature at a second socket and outputs a second temperature signal correspondingly, the comparison circuit comprises a first comparator, a second comparator, a sixth electronic switch, a seventh electronic switch, and an OR gate, a non-inverting terminal of the first comparator receives the reference temperature signal, an inverting terminal of the first comparator receives the first temperature signal, an output terminal of the first comparator is connected to a first terminal of the sixth electronic switch, a second electronic switch is grounded, a third terminal of the sixth electronic switch is connected to a power supply through a fifth resistor, the third terminal of the sixth electronic switch is further connected to a first input terminal of the OR gate through a sixth resistor, a non-inverting terminal of the second comparator receives the reference temperature signal, an inverting terminal of the second comparator receives the second temperature signal, an output terminal of the second comparator is connected to a first terminal of the seventh electronic switch, a second terminal of the seventh electronic switch is grounded, a third terminal of the seventh electronic switch is connected to the power supply through a seventh resistor, the third terminal of the seventh electronic switch is connected to a second input terminal of the OR gate through an eighth resistor, an output terminal of the OR gate is connected to the alarm circuit.
